(19) United States
(12) Patent Application Publication
(10) Pub. No.: US 2007/0261794 A1
(43) Pub. Date: Nov. 15, 2007

(54) Apparatus for sealing issued documents used in device for issuing documents and method for sealing documents

(75) Inventor: Sa-Hyuk Hong, Hwaseong-si (KR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: ANYTEKSYS CO., LTD.

(21) Appl. No.: 11/713,743

(22) Filed: Mar. 5, 2007

(30) Foreign Application Priority Data
May 15, 2006 (KR) 10-2006-0043239
May 30, 2006 (KR) 10-2006-0048514

(51) Int. Cl. B65C 9/18

(52) U.S. Cl. 156/541

(57) ABSTRACT

Disclosed herein is an apparatus for sealing documents used in a device for issuing documents comprising: a driven roller fixing by a sealing sheet tape on which a sealing sheet tape is attached; a winding roller provided close to the driven roller and on which an end of a sealing sheet tape fixed to the driven roller is fixed; a sealing sheet exfoliation section provided in the middle of the sealing sheet tape passing through between the driven roller and the winding roller and fixing the sealing sheet in the tape body at the state of being detached from the tape body; and a sealing sheet pressing roller section pressing the attached sealing sheet to be closely adhered when the detached sealing sheet is attached to a document. It is possible to easily attach and detach the sealing sheet to and from a winding tape and to prevent false attachments of the sealing sheet and disability of attachment when a sealing sheet is attached. The sealing sheet can be attached to an issued document firmly regardless of the thickness of the document and the sealing sheet tape is replaced and provided again after the sealing sheet was wound. Therefore, it is possible to provide with a reusable module for a sealing apparatus with excellent operational effects.

### BACKGROUND OF THE INVENTION

1. Field of the Invention

The present invention relates, generally, to apparatuses for sealing issued documents used in a device for issuing documents and methods for sealing documents, more particularly, to an apparatus for issuing documents used in a device for issuing documents which can extend the durable lifetime of a machine, easily distinguish if a sealing sheet is opened, and avoid a method for verifying documents using perforations to apply a heavy load onto a device for issuing documents by attaching the sealing sheet having a contact surface for the purpose of preventing the counterfeit of the documents whose true or false is considered important such as a real-estate registered copy or a building registered copy.

2. Description of the Related Art

In general, a laser printer is embedded in an apparatus for automatically issuing various evidential documents such as a register registration copy or a resident registration copy and a document handling clutch is provided on the output section of the laser printer to attach the seal of the chief of department in charge and a tombstone seal at the last page of the document outputted from the laser printer, and an authentication text is sealed. Then, the document is laterally arranged and if the issued documents have at least two pages, a perforation operation is performed and the issued documents are held by a stapler to carry out a holding operation, and pushed out and the documents are issued. In addition, a certificate stamp issuing machine used for verifying a document by a manual work also performs a perforation at a pre-set position of a document for the verification of documents. In the conventional document issuing machine, a perforator should be provided in consideration of the thickness of the thickest document due to perforations in order to prevent the counterfeit of a document. Therefore, it has problems that the perforator is heavy due to the complicated configurations and a lot of loads are applied when a perforation is performed to apply an excessive power to itself. Therefore, the durable lifetime of the machine is shortened and a lot of power is consumed and further a noise seriously occurs when it is operated. Moreover, the maximum of the number of the documents to be verified is 20 to 30 due to the mechanical limit. In order to solve the problems, the applicant of the present invention suggested a machine for automatically issuing documents having a sealing section performing a seal without perforating a document for the purpose of proving the authenticity of a document in Korean Patent No. 10-376369. However, the referenced machine has problems that the moving distance of the tape using a sealing sheet increases as much as the increasing winding diameter of a winding roller so that a sealing sheet is not fixed at the position which was originally planned to be attached at use, and when a sealing sheet is detached from the sealing sheet tape, it is detached from the surface of the sealing sheet tape such that it cannot support the sealing sheet at the state of being prepared to be attached. Therefore, the sealing sheet cannot be perfectly attached. In addition, it was not easily determined if the reattachment is carried out in case that a sealing sheet is attached on a document and the sealing sheet was precisely detached and then attached again.

### SUMMARY OF THE INVENTION

Accordingly, the present invention has been made keeping in mind the above problems occurring in the related art, and an object of the present invention is to provide an apparatus for sealing issued documents used in a device for issuing documents without malfunctions like a false attachment or a disability of attachments of the sealing sheet by making it easy that a sealing sheet is detached and attached easily from and to the winding tape of a sealing sheet.

Another object of the present invention is to provide an apparatus for sealing issued documents used in a device for issuing documents which can attach a sealing sheet to an issued document when a sealing sheet is attached in spite of the thickness of the documents.

A further object of the present invention is to provide an apparatus for sealing issued documents used in a device for issuing documents which can be conveniently used by providing a sealing apparatus module capable of being repeatedly used like that a sealing sheet tape is replaced and established again, after a sealing sheet is wound.

A further object of the present invention is to provide a method for sealing documents capable of easily recognizing if the sealing sheet is opened because the sealing sheet is broken in case that the sealing sheet is sealed and then torn off.

The above objects of the present invention can be attained by an apparatus for sealing documents used in a device for issuing documents comprising: a driven roller fixing the sealing sheet tape on which a sealing sheet is attached; a winding roller provided close to the driven roller and on which an end of the sealing sheet tape fixed to the driven roller is fixed; a sealing sheet exfoliation section provided in the middle of the sealing sheet tape passing through between the driven roller and the winding roller, and fixing the sealing sheet in the tape body at the state of being detached from the tape body; and a sealing sheet pressing roller section pressing the attached sealing sheet to be closely adhered when the detached sealing sheet is attached to a document.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic front cross-sectional view of an apparatus for sealing issued documents used in a device for issuing documents in accordance with an embodiment of the present invention; and

FIG. 2 is a perspective view of a sealing device module of an apparatus for sealing issued documents;

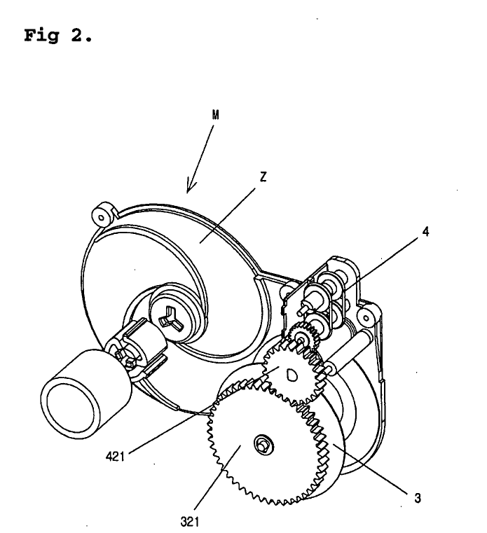

FIG. 3 is a perspective view showing a silicon belt transfer section;

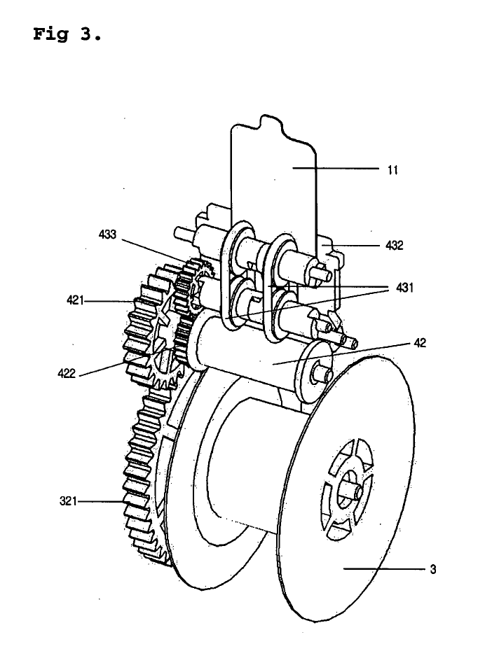

FIG. 4 is a schematically enlarged longitudinal cross-sectional view of a sealing sheet exfoliation section showing that the sealing sheet is exfoliated from the sealing tape;

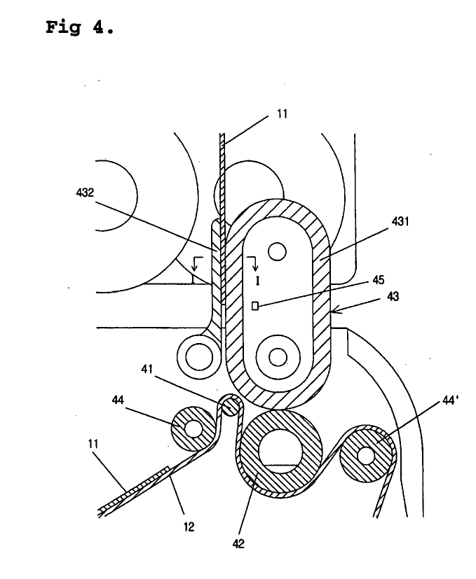

FIG. 5 is a transverse cross-sectional view taken along line I-I of FIG. 4;

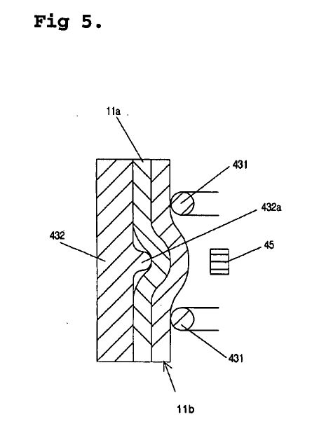

FIG. 6 is a cross-sectional view of a sealing sheet pressing roller section;

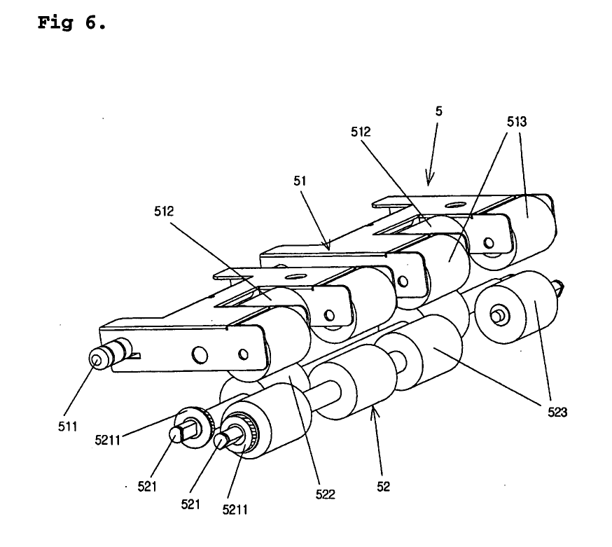

FIG. 7 is a front view showing the operations of the sealing sheet pressing roller section; and

FIG. 8 is a longitudinal cross-sectional view of a winding roller.

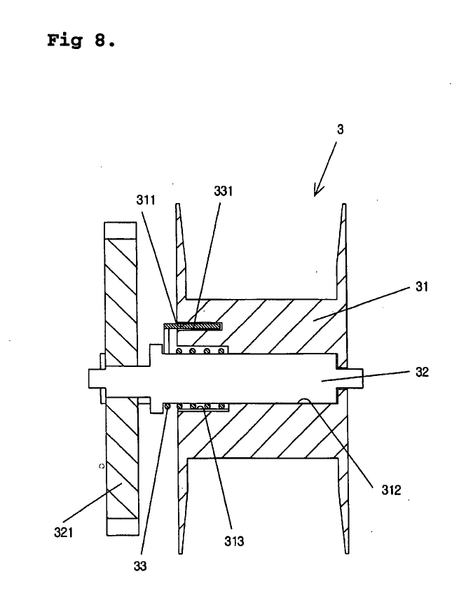

### DESCRIPTION OF THE PREFERRED EMBODIMENTS

A better understanding of the apparatus for sealing issued documents used in a device for issuing documents and a method for sealing documents according to the present invention may be obtained in light of the following examples which now will be set forth to illustrate with reference to the attached drawings.

The apparatus (A) for sealing issued documents used in a device for issuing documents according to the present invention is provided at the side of an outlet of a device for issuing documents (B) where necessary documents are printed and stapled to be let out.

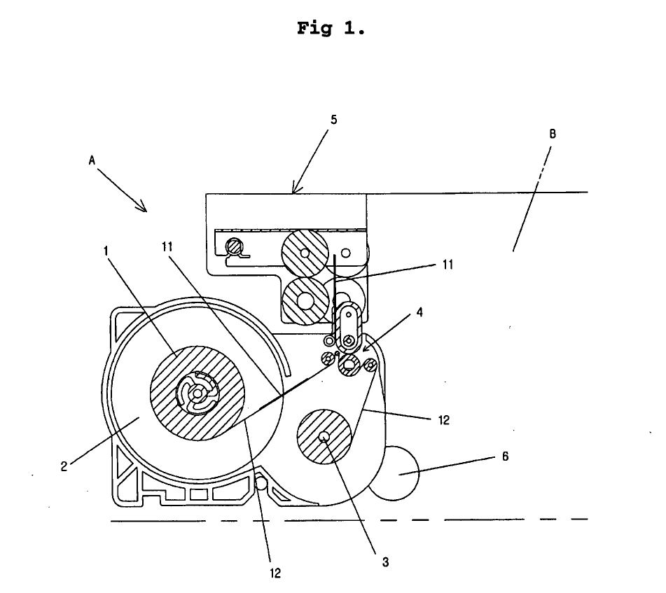

The apparatus (A) for sealing issued documents used in a device for issuing documents, as shown in FIG. 1, comprises: a driven roller (2) fixing a sealing sheet tape (1) on which a sealing sheet (11) is attached; a winding roller provided close to the driven roller and on which an end of the sealing sheet tape fixed to the driven roller is fixed; a sealing sheet exfoliation section provided in the middle of the sealing sheet tape passing through between the driven roller and the winding roller and fixing the sealing sheet in the tape body at the state of being detached from the tape body; and a sealing sheet pressing roller section pressing the attached sealing sheet to be closely adhered when the detached sealing sheet is attached to a document.

The sealing sheet tape (1) has the structure where a sealing sheet (11) is separately attached with a determined interval on a band-shaped tape body (12), and the sealing sheet (11) has a vinyl body (11a) and a hologram printing contact layer (11b) attached on the vinyl body (11a) but capable of being fractured. When the sealing sheet (11) attached on the issued document (11) is opened, the hologram printing contact layer (11b) is fractured and it is possible to easily recognize if it is opened. The hologram printing contact layer (11b) is formed of a silver thin film contact layer capable of being fractured in the present embodiment but other materials similar to the silver thin film contact layer capable of easily being fractured can be used also.

In addition, a paper sticker may be used as the sealing sheet (11) of the sealing sheet tape (1). In other words, a sheet may be used in place of the vinyl body (11a) and a separable cohesive layer may be formed in place of the separable hologram printing contact layer (11b).

The sealing sheet (11) using a paper is torn off in case that the sheet is detached from the cohesive layer by force because the cohesiveness of the cohesive layer is strong. Therefore, it is easily distinguished if the sealing has been opened.

The sheet may be anything which can be printed on the surface, for example, a coated paper, a simili, an art paper, snow white paper, etc. In addition, the cohesive layer may use a vinyl resin type additive, a polyvinyl acetate type (PVAc) additive or a chloroprene type additive.

The driven roller (2), the winding roller (3) and the sealing sheet exfoliation section (4) are integrally formed to configure a sealing apparatus module which is detachably coupled with the apparatus for sealing issued documents (A), and the sealing apparatus module (M) has a constitution that the sealing sheet tape (1) is used and then replaced with another to be used further.

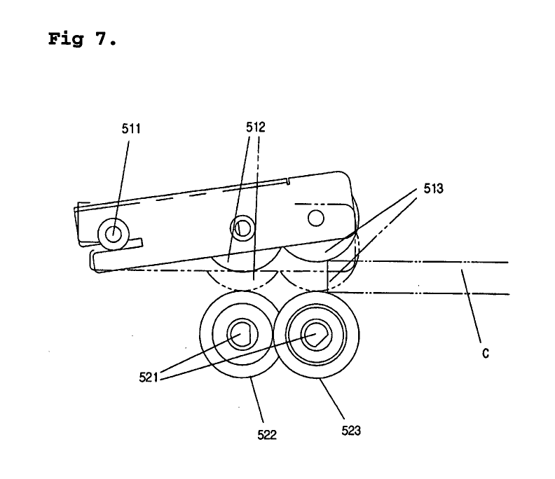

The winding roller (3) is driven by a driving motor (6). The driving motor (6) is a DC motor provided with by a step motor or a tacho generator, employing a motor capable of controlling the velocity and positions, whose rotations are precisely controlled by a photosensitive sensor provided in the sealing sheet exfoliation section (4) which will be described as following. The winding roller (3), as shown in FIG. 7, comprises: a driving axis (32) for driving a roller body (31) on which a tape body (12) is wound, a slip spring (33) with a smaller diameter than that of the driving axis (32) to be fixed abutting to the driving axis (32) and having a coupling end (331) extended in a transverse direction at an end, and a roller body (31) having a coupling hole (313) coupled with a coupling end (331) of the slip spring (33), and an axis hole (312) through which the driving axis (32) is inserted in the center and the insertion hole (313) disposing the slip spring (33) at an end of the axis hole (312). The driving axis (32) is coupled with the driving gear (321) engaged with the sealing sheet exfoliation section (4) at an end. In the present embodiment, the slip spring (33) has the diameter of 5.8 mm and the driving axis (32) coupled with the slip spring (33) has the diameter of 6.0 mm, in other words the slip spring (33) and the driving axis (32) have the structure to be tightly contacted and coupled.

The sealing sheet exfoliation section comprises: a turning axis (41) provided in the upward direction of the winding roller so that the sealing sheet tape (1) proceeding toward the driven roller (2) and the winding roller (3) can be rapidly redirected; a friction roller (42) provided close to the turning axis (41) in the upper direction of the winding roller (3) and having a driven gear (421) engaged with the driving gear of the winding roller (3) at a side to be interlocked with the winding roller (3); a silicon belt transfer section (43) interlocked with the friction roller (42) and line-contacting the sealing sheet (11) detached from the sealing sheet tape (1) to move it in the upward direction. A rubber with excellent friction is formed on the external surface of the friction roller (42) so that the tape body (12) from which the sealing sheet (11) is detached is perfectly transferred and is perfectly interlocked with the silicon belt (431) of the silicon belt transfer section (43) by the driven gear (421) formed at an end of the friction roller (42) and the silicon belt gear (433) engaged with the other driven gear (422). The silicon belt transfer section (43) comprises two silicon belts (431) interlocked with the friction roller (42) and a guide plate (432) provided close to the silicon belt (431) to support the detached sealing sheet (11). The silicon belt (431) is formed of a silicon material so that it is not attached even if it approaches to the contact surface (11b) of the sealing sheet (11). The surface to be contacted is circularly formed to be line-contacted in order to minimize contacts. The guide plate (432) has the structure that the sealing sheet (11) is attached on the issued document (C) at an erect state in order to avoid the phenomenon that the sealing sheet (11) is bent by being separated to form a curve in the middle of the detached sealing sheet (11), while forming a protruding projection (432a) extended in a longitudinal direction on the surface contacting the sealing sheet (11). The unexplained signs (44, 44′) are guide rollers for guiding a sealing tape. The unexplained sign (45) is a photosensitive sensor to detect if a sealing sheet (11) is lead in. If the sealing sheet is detected, the detected signal is remitted to the driving motor (6) to control the drivings of the driving motor (6).

The sealing sheet pressing roller section (5) is disposed in the upward direction of the sealing sheet exfoliation section (4) where the sealing sheet (11) detached from the sealing sheet exfoliation section (4) is disposed. The sealing sheet pressing roller section (5) comprises: an upper pressing roller (51) and a lower pressing roller (52) so that an issued document (C) passes therebetween, the upper pressing roller (51) rotates about the center of the hinge axis (511). The upper pressing roller (51) has a front roller (512) close to the hinge axis (511) and the rear roller (513) at the rear thereof to be rotated along with the center of the hinge axis. The front roller (512) is disposed at the position where an issued document pressing the sealing sheet (11) is stapled, and the rear roller (513) is disposed at both sides of the front roller (512). The upper pressing roller (51) comprises two front rollers (512) and four rear rollers (513) while the lower pressing roller (52) comprises two front rollers (522) and four rear rollers (523) at the positions corresponding to those of the upper pressing roller (51). The sealing sheet pressing roller section (5) has the structure that the front roller (512) is adhered closely to attach the sealing sheet (11) because the rear rollers (513, 523) abut to the position where the stapled issued document (C) is lead in earlier and the rear roller (513) rotates in the upward direction about the center of the hinge axis (511) so that the front roller (512) is lifted up higher than the rear roller (513). The roller axis (521) of the lower pressing roller (52) of the sealing sheet pressing roller section (5) is driven by the driven gear (5211) meshed with the driving gear (61) of the driving motor (6′).

### DETAILED DESCRIPTION OF THE INVENTION

Hereinafter, the operations of the apparatus for sealing issued documents used in a device for issuing documents according to the present invention having the above-mentioned configuration will be described.

If the stapled issued document (C) is stopped at the direct front of the sealing sheet exfoliation section (4), and detected and then lead into the sealing sheet exfoliation section (4), the front end of the issued document (C) approaches the rear rollers (513, 523) of the sealing sheet pressing roller section (5) first and at the same time the upper pressing roller (51) is lifted up in the upward direction, while being rotated along the center of the hinge axis (511). The sealing sheet (11) is detached at the state that the rear roller (513) presses the front end of the issued document (C) and then attached to an issued document (C) disposed in the position where the issued document (C) will be attached. Likewise, at the state that the issued document (C) is attached to a sealing sheet, the issued document (C) is lead into the front rollers (512, 522) and the distance between the front rollers (512, 522) is formed to be narrower than that between the rear rollers (513, 523), therefore, the sealing sheet (11) attached in the position of the issued document (C) to be stapled is tightly attached on the staple. As described above, the present invention has the structure that the upper pressing roller (51) is rotated about the hinge axis (51) and the front rollers (512, 522) pressing the sealing sheet have smaller interval than the rear rollers (513, 523) so that the sealing sheet is tightly attached to the issued document to rotate the upper pressing roller (51) in spite of the thickness of the issued document.

If the sealing of the issued document (C) is completed, the driving motor (6) of the winding roller (3) is operated in order to prepare for sealing the document to be issued next. As the driving axis (32) is rotated, the roller body (31) is rotated and the tape body (12) from which the sealing sheet (11) is detached winds the sealing sheet (11) winding the winding roller (3) and the sealing sheet tape (1) winding the driven roller (2) is unwound. The sealing sheet (11) attached on the sealing sheet tape (1) passing through the turning axis (41) of the sealing sheet exfoliation section (4) is moved in the upward direction by the silicon belt (431) of the silicon belt transfer section (43) because the sealing sheet (11) is rapidly redirected along the turning axis (41). At this time, the silicon belt (431) is formed of a silicon material so that even if it abuts to the hologram printing contact layer (11b) of the sealing sheet (11), it is not adhered to the hologram printing contact layer (11b), and the contact surface is formed circularly so that the face to be contacted is contacted in a line in order to minimize contacts. The sealing sheet (11) is easily disposed in a position where the document to be issued next is sealed and the driving motor (6) of the winding roller (3) is stopped. In the present invention, the sealing sheet (11) having the detached hologram printing contact layer is moved to a position where it can be attached to the issued document (C) by the silicon belt (431) and the guide plate (432), therefore the stable attachment of the sealing sheet can be guaranteed.

In addition, if the thickness of the tape body (12) of the sealing sheet tape (1) winding the winding roller (3) is increased, the unwound length of the sealing sheet tape (1) attached by the sealing sheet (11) is increased by one turn. In order to solve the problem that the sealing sheet (11) is not detached at the appropriate position, if the thickness of the tape body (12) winding the winding roller (3) is thicken, the tension applied onto the sealing sheet tape (1) is increased. The increased tension is amended as the roller body (31) and the slip spring (33) transmitting the driving force of the driving axis (32) are slipped on the driving axis (32). Therefore, the length of the sealing sheet tape winding the winding roller (3) is maintained to be persistent and it is possible to set the position of the sealing sheet (11) constant, resulting in performing the stable sealing operation. Likewise, in case that the sealing sheet is attached on the staple section, the hologram printing contact layer (11b) is fractured and broken when the sealing sheet (11) is opened at the time of removing the sealing sheet which have been attached once to remove the trace of tearing, resulting in performing peculiar functions of verifying documents.

As described above, an apparatus for sealing documents used in a device for issuing documents according to the present invention comprises: a driven roller fixing a sealing sheet tape on which a sealing sheet is attached; a winding roller provided close to the driven roller and on which an end of a sealing sheet tape fixed to the driven roller is fixed; a sealing sheet exfoliation section provided in the middle of the sealing sheet tape passing through between the driven roller and the winding roller and fixing the sealing sheet in the tape body at the state of being detached from the tape body; and a sealing sheet pressing roller section pressing the attached sealing sheet to be closely attached when the detached sealing sheet is attached to a document. It is possible to easily attach and detach a sealing sheet to and from a winding tape and to prevent false attachments of the sealing sheet and disability of attachment when a sealing sheet is attached. The sealing sheet can be attached to an issued document firmly regardless of the thickness of the document and the sealing sheet tape is replaced and provided again after the sealing sheet was wound. Therefore, it is possible to provide with a reusable module for a sealing apparatus with excellent operational effects.

### CROSS-REFERENCE TO RELATED APPLICATIONS

This application claims priority of Korean Patent Application Nos. 10-2006-0048514; and 10-2006-0043239, filed May 30, 2006; and May 15, 2006, respectively, the entire contents of which are incorporated herein by reference.

What is claimed is:

1. An apparatus for sealing documents used in a device for issuing documents comprising:
a driven roller fixing a sealing sheet tape on which a sealing sheet is attached;
a winding roller provided close to the driven roller and on which an end of the sealing sheet tape fixed to the driven roller is fixed;
a sealing sheet exfoliation section provided in the interim of the sealing sheet tape passing through between the driven roller and the winding roller and fixing the sealing sheet in the tape body at the state of being detached from the tape body; and
a sealing sheet pressing roller section pressing the attached sealing sheet to be closely adhered when the detached sealing sheet is attached to a document,
the sealing sheet exfoliation section comprising: a turning axis provided in the upward direction of the winding roller so that the sealing sheet tape can be rapidly redirected; a friction roller provided close to the turning axis in the upward direction of winding roller, having a driven gear engaged with the driving gear of the winding roller at a side to be interlocked with the winding roller; a silicon belt transfer section interlocked with the friction roller and line-contacting the sealing sheet detached from the sealing sheet tape to move the sealing sheet in the upward direction.

2. The apparatus for sealing documents used in a device for issuing documents as set forth in claim 1,
wherein the silicon belt transfer section comprises: a silicon belt interlocked with the friction roller and a guide plate provided close to the silicon belt to support the detached sealing sheet, and the silicon belt is formed of silicon material so that even if it contacts with a hologram contact layer of the sealing sheet, it is not attached and the surface to be contacted is formed to be line-contacted to minimize the contact surface.

3. The apparatus for sealing documents used in a device for issuing documents comprising:
a driven roller fixing a sealing sheet tape on which a sealing sheet is attached;
a winding roller provided close to the driven roller and on which an end of the sealing sheet tape fixed to the driven roller is fixed;
a sealing sheet exfoliation section provided in the interim of the sealing sheet tape passing through between the driven roller and the winding roller and fixing the sealing sheet in the tape body at the state of being detached from the tape; and
a sealing sheet pressing roller section pressing the attached sealing sheet to be closely adhered when the detached sealing sheet is attached to a document,
wherein the sealing sheet pressing roller section comprises: an upper pressing roller and a lower pressing roller so that an issued document passes therebetween, the upper pressing roller having a front roller close to a hinge axis and a rear roller at the rear thereof to be rotated about the center of the hinge axis, the front roller being disposed at the position where an issued document pressing a sealing sheet is stapled, the lower pressing roller comprising a front roller and a rear roller at the positions corresponding to the upper pressing roller and the distance between the rear rollers being narrower than that between front rollers when an issued document is lead in.

4. The apparatus for sealing documents used in a device for issuing documents comprising:
a driven roller fixing a sealing sheet tape on which a sealing sheet is attached;
a winding roller provided close to the driven roller and on which an end of the sealing sheet tape fixed to the driven roller is fixed;
a sealing sheet exfoliation section provided in the interim of the sealing sheet tape passing through between the driven roller and the winding roller and fixing the sealing sheet in the tape body at the state of being detached from the tape; and
a sealing sheet pressing roller section pressing the attached sealing sheet to be closely adhered when the detached sealing sheet is attached to a document,
the winding roller comprising a driving axis for driving a roller body along which a tape body is wound, a slip spring with a smaller diameter than that of the driving axis to be fixed close to the driving axis and having a coupling end extended in a transverse direction at an end, and a roller body having a coupling hole coupled with a coupling end of the slip spring, an axis hole through which the driving axis is inserted in the center, and an insertion hole disposing the slip spring at an end of the axis hole.

5. The apparatus for sealing documents used in a device for issuing documents comprising:
a driven roller fixing by a sealing sheet tape on which a sealing sheet is attached;
a winding roller provided close to the driven roller and on which an end of the sealing sheet tape fixed to the driven roller is fixed;
a sealing sheet exfoliation section provided in the interim of the sealing sheet tape passing through between the driven roller and the winding roller and fixing the sealing sheet by way of the tape body at the state of being detached from the tape body; and
a sealing sheet pressing roller section pressing the attached sealing sheet to be closely adhered when the detached sealing sheet is attached to a document,
the winding roller comprising a driving axis for driving a roller body on which a tape body is wound, a slip spring with a smaller diameter than that of the driving axis to be fixed close to the driving axis and having a coupling end extended in a transverse direction at an end, and a roller body having a coupling hole coupled with a coupling end of the slip spring, an axis hole through which the driving axis is inserted in the center, and an insertion hole disposing the slip spring at an end of the axis hole;
wherein the sealing sheet exfoliation section comprises: a turning axis provided in the upward direction of the winding roller so that the sealing sheet tape can be rapidly redirected; a friction roller provided close to the turning axis in the upward direction of winding roller, having a driven gear engaged with the driving gear of the winding roller at a side to be interlocked with the winding roller; a silicon belt transfer section friction-contacted with the friction roller and line-contacting the sealing sheet detached from the sealing sheet tape to move the sealing sheet in the upward direction; and
wherein the sealing sheet pressing roller section comprises: an upper pressing roller and a lower pressing roller so that an issued document passes therebetween, the upper pressing roller having a front roller close to a hinge axis and a rear roller at the rear thereof to be rotated about the center of the hinge axis, the front roller being disposed at the position where an issued document pressing a sealing sheet is stapled, the lower pressing roller comprising a front roller and a rear roller at the positions corresponding to the upper pressing roller and the distance between the rear rollers being narrower than that between front rollers when an issued document is lead in.

6. A method for sealing documents characterized by attaching a vinyl body to a sealing sheet having a separable hologram printing contact layer attached on the vinyl body on a staple holding an issued document so that the hologram printing contact layer is broken when the sealing sheet attached on the issued document is opened.

7. The apparatus for sealing an issued document used in a device for issuing documents as set forth in claim 2, wherein the guide plate has a protruding projection extended in a longitudinal direction on a surface contacting the sealing sheet.

8. The method for sealing documents characterized by attaching a sheet on a staple holding an issued document to a sealing sheet having a separable cohesive layer attached on the sheet so that the sheet is broken when the sealing sheet attached on the issued document is opened.
